(19) United States
(12) Patent Application Publication
(10) Pub. No.: US 2021/0132276 A1
(43) Pub. Date: May 6, 2021

(54) POLYMER INFRARED POLARIZER

(71) Applicant: Indiana University Research and Technology Corporation, Indianapolis, IN (US)

(72) Inventor: Jong Eun Ryu, Carmel, IN (US)

(73) Assignee: Indiana University Research and Technology Corporation, Indianapolis, IN (US)

(21) Appl. No.: 16/756,986

(22) PCT Filed: Oct. 18, 2018
(86) PCT No.: PCT/US18/56415

§ 371 Date: Apr. 17, 2020

Related U.S. Application Data
(60) Provisional application No. 62/575,169, filed on Oct. 20, 2017.

(51) Int. Cl. G02B 5/30; G02B 5/18

(52) U.S. Cl. CPC G02B 5/3041; G02B 5/18

(57) ABSTRACT

A polymer infrared polarizer (100) comprising a transparent polymer substrate (110) formed of a high sulfur content polymeric material, and a metal layer (130) fixed to an upper surface (120) of the transparent polymer substrate (110).

### RELATED APPLICATIONS

The present disclosure is related to and claims priority to U.S. Provisional Application No. 62/575,169, entitled “POLYMER INFRARED POLARIZER,” filed on Oct. 20, 2017, the entire disclosure of which is hereby expressly incorporated herein by reference.

### RESEARCH OR DEVELOPMENT

This invention was made with government support under FA8650-16-D-5403 awarded by the Air Force Research Laboratory. The government has certain rights in the invention.

### FIELD OF THE DISCLOSURE

The present disclosure relates generally to a polymer infrared polarizer, and more specifically, to a polymer infrared polarizer having a polymer substrate formed of a high sulfur content polymeric material and a metal layer fixed to an upper surface of the polymer substrate.

### BACKGROUND OF THE DISCLOSURE

A polarizer is an optical filter that lets light waves of a specific polarization pass and blocks light waves of other polarizations. By removing polarized light, reflections and glare are reduced and color saturation is increased to provide an overall improved image. With reference to FIG. 1, one type of polarizer is a wire grid polarizer 10. A wire grid polarizer 10 includes a transparent substrate 12 with an array of thin metal lines/wires 14 closely spaced sitting on its upper surface. The metal lines/wires 14 of a wire grid polarizer 10 only allow light oscillating perpendicular to them, or within the transverse magnetic field (TM), to pass through. Light oscillating in parallel with the wires 14, or within the transverse electric field (TE), will generate electron movement along the wires 14 in response to the oscillating field. The electron movement creates a travelling wave cancelling the incoming waves oscillating parallel to the wires and reflects it in the same manner as a thin metal sheet. The components of the incoming wave having a polarization parallel to the wires 14 are thus reflected with some loss due to Joule heating caused by electron movement in the wires 14. Since only a specific polarization is allowed through the wire grid polarizer 10, the outgoing wave will have a single linear polarization.

FIG. 1 shows the general working principle of a wire grid polarizer 10. An extinction ratio of a polarizer is a measure of its ability to attenuate a plane polarized beam. In general, the extinction ratio is a ratio of optical powers of perpendicular polarizations (i.e., transverse electric field, TE, and transverse magnetic field, TM). The extinction ratio (E) is given as E=TM/TE and expressed as a ratio (e.g., R=100:1). In general, a good commercial grade polarizer will have an extinction ratio of 100-500. The extinction ratio is important because it is a measure of the polarization-maintaining performance of an optical fiber.

Current infrared (IR) polarizers are made with inorganic transparent substrates such as barium fluoride (BaF₂), calcium fluoride (CaF₂), zinc selenide (ZnSe), zinc sulfide (ZnS), Germanium (Ge), Gallium Arsenide (GaAs), Thallium Bromoiodide (KRS-5), and iron (Fe). However, IR polarizers made with inorganic substrates are often expensive, time consuming to manufacture, easy to break and/or difficult to manage and/or shape. Thus, an infrared polarizer is needed that provides the advantages of easy manufacturing, low cost, durability, lightweight, and/or easy to manage and/or shape.

### SUMMARY OF THE DISCLOSURE

In one embodiment of the present disclosure, a polymer infrared polarizer is provided. The polymer infrared polarizer comprises a transparent polymer substrate formed of a high sulfur content polymeric material and a metal layer fixed to an upper surface of the transparent polymer substrate.

In one aspect of the polymer infrared polarizer, the metal layer is formed of one of gold, silver, and aluminum.

In a further aspect of the polymer infrared polarizer, the upper surface of the transparent polymer substrate is smooth.

In another aspect of the polymer infrared polarizer, the transparent polymer substrate has indentations within the upper surface.

In another embodiment of the present disclosure, a method for forming a polymer infrared polarizer is disclosed. The method comprises applying a metal layer to an upper surface of a transparent polymer substrate, where the transparent polymer substrate is formed of a high sulfur content polymeric material.

In one aspect, the method further includes altering the upper surface of the transparent polymer substrate, there the step of altering the upper surface of the transparent polymer substrate includes one of stamping, injection molding, 3-D printing, and an etching of the substrate.

In another aspect of the method, the step of altering the upper surface of the transparent polymer substrate occurs one of prior to and simultaneously with the step of applying the metal layer to the upper surface of the transparent polymer substrate.

In a further aspect of the method, the step of applying a metal layer to the upper surface of the transparent polymer substrate includes one of deposition, evaporation, and transfer printing of the metal layer onto the upper surface.

In another aspect of the method, the upper surface is smooth and continuous.

In a further aspect of the method, the upper surface includes indentations.

In yet another embodiment of the present disclosure, a polymer infrared polarizer is provided that includes a transparent polymer substrate having an upper surface, and a metal layer disposed on the upper surface of the transparent polymer substrate, wherein the transparent polymer substrate includes a polymeric composition having a copolymer of sulfur.

In one example, the upper surface of the transparent polymer substrate includes a plurality of spaced apart indentations creating a plurality of upward extensions.

In another example, the upper surface of the transparent polymer substrate includes a top upper surface including tops of each extension of the plurality of extensions, and a bottom upper surface including surfaces between each extension of the plurality of extensions.

In yet another example, a pitch between corresponding points on adjacent extensions of the transparent polymer substrate is approximately 400 nanometers to approximately 1 micrometer.

In still another example, a height of each extension of the plurality of extensions is approximately 100 nanometers to approximately 200 nanometers.

In a further example, a height of a body of the transparent polymer substrate is approximately 10 micrometers to approximately 500 micrometers.

In a yet further example, each extension of the plurality of extensions includes straight edges such that side surfaces and a top surface of each extension of the plurality of extensions form an approximately 90-degree angle.

In a still further example, each extension of the plurality of extensions includes a rounded top surface.

In still yet another example, the metal layer includes a vertical layer extending up sides of a base of each extension of the plurality of extensions.

In a still yet further example, the upper surface of the transparent polymer substrate includes at least one of: a bi-layer structure or a single-layer structure.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 shows a perspective view of a general working principle of a wire grid polarizer;

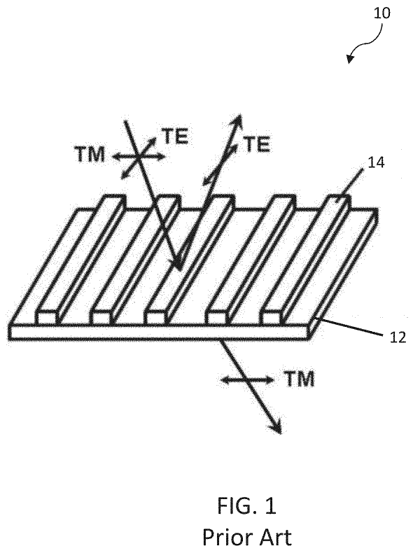

FIG. 2 shows a cross-sectional view of an embodiment of a polymer infrared polarizer of the present disclosure, where the polymer infrared polarizer has a bi-layer structure;

FIG. 3 shows a perspective view of a cross-section of the embodiment of the polymer infrared polarizer of FIG. 2;

FIG. 4 shows a perspective view of a cross-section of a portion of another embodiment of a polymer infrared polarizer of the present disclosure;

FIG. 5 shows a cross-sectional view of yet another embodiment of a polymer infrared polarizer of the present disclosure, where the polymer infrared polarizer has a single layer with grating structure;

FIG. 6A-F shows a schematic of an embodiment of a method for producing a polymer infrared polarizer of the present disclosure;

FIG. 7 shows cross-sectional views of step-by-step products of the method of FIG. 4;

FIG. 8 shows cross-sectional views of step-by-step products of another embodiment of a method for producing a polymer infrared polarizer of the present disclosure; and

FIG. 9 shows cross-sectional views of step-by-step products of yet another embodiment of a method for producing a polymer infrared polarizer of the present disclosure.

### DETAILED DESCRIPTION OF EMBODIMENTS

The embodiments disclosed herein are not intended to be exhaustive or to limit the disclosure to the precise forms disclosed in the following detailed description. Rather, the embodiments were chosen and described so that others skilled in the art may utilize their teachings.

There has been no plastic IR polarizer in the market due to a low IR transmission of carbon-based polymers while there have been plastic alternatives for visible wavelengths, which provides the advantages of easy manufacturing, low cost, safety, durability, and lightweight. For example, mid-infrared (3 um-5 um) IR linear polarizers can be used in imaging devices to enhance contrast and definition of image. It also enables to distinguish the radiations of man-made and natural materials. In one embodiment, a high extinction ratio polarizer is utilized using nanomanufacturing on the sulfur based IR transparent substrate.

There has been no IR polarizer based on a plastic substrate. Disadvantages of the current inorganic IR transparent substrates for polarizer include brittleness (mechanically easy to break) and high material cost. In this disclosure, a mid-IR polarizer is provided by using a cheap polymer material and scalable nanoscale manufacturing. Compared to the existing products, this new plastic polarizer has advantages of 1) durability, 2) heal-ability, 3) significantly lowered material cost, 4) easier fabrication, and 5) mass-manufacturability (e.g., plastic is able to be shaped by low cost manufacturing techniques such as injection molding).

### 1. Polymer Infrared Polarizer

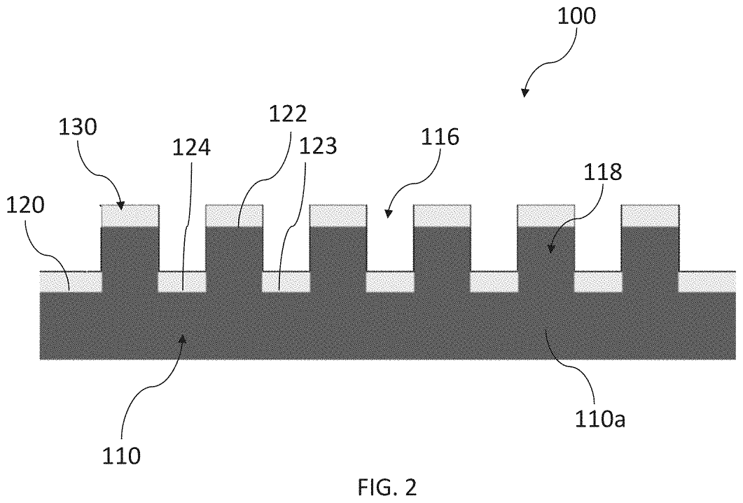

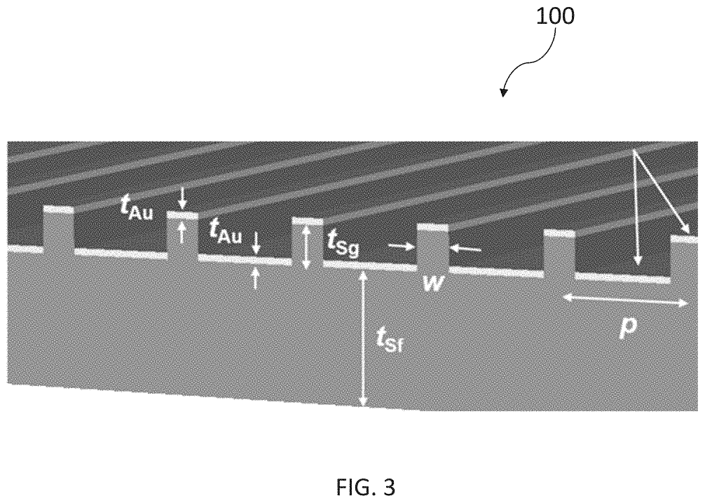

A polymer infrared polarizer is disclosed that is durable, lightweight, low cost, easily produced, and easy to manage/shape. Referring to FIGS. 2-5, embodiments of a polymer infrared polarizer 100, 200 of the present disclosure are shown. In the illustrative embodiments of FIGS. 2-5, polymer infrared polarizer 100, 200 includes a transparent polymer substrate 110, 210 and a metal layer or grating 130, 230, where polarizer 100, 200 is configured to let light waves of a specific polarization pass (i.e., transverse magnetic field, TM, or waves perpendicular to metal layer or grating 130, 230) and block light waves of other polarizations (i.e., transverse electric field, TE, or waves parallel to metal layer or grating 130, 230). In general, polymer infrared polarizers 100, 200 of the present disclosure include an extinction ratio of approximately 150-250.

Polymer substrate 110, 210 is generally formed of a high sulfur content polymeric material. The high sulfur content polymeric material may include a polymeric composition comprising a copolymer of sulfur, at a level in the range of at least about 50 wt. % of the copolymer, and one or more monomers each selected from the group consisting of ethylenically unsaturated monomers, epoxide monomers, and thiirane monomers, at a level in the range of about 0.1 wt. % to about 50 wt. % of the copolymer. In certain embodiments, the polymeric composition may include between 70 to about 92 wt. % of the copolymer of sulfur, and one or more monomers at a level in the range of about 8 wt. % to about 30 wt. % of the copolymer. In an exemplary embodiment, the polymeric composition includes 70 wt. % of the copolymer of sulfur. Further details of the high sulfur content polymeric material may be found in PCT Patent Application Publication No. WO 2013/023216, which is incorporated by reference herein.

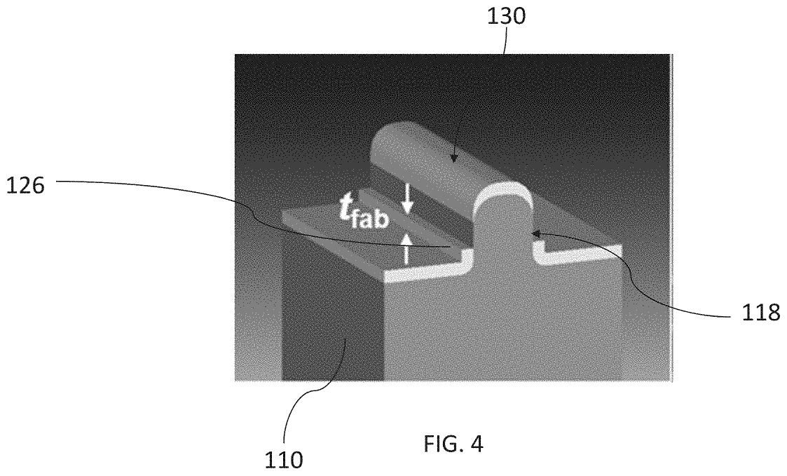

With reference to FIG. 2-4, in various embodiments, polymer substrate 110 includes spaced apart indentations 116 creating upward extensions 118. As such, an upper surface 120 of polymer substrate 110 includes a top upper surface 122 including tops of each extension 118 and a bottom upper surface 123 including surfaces between each extension 118. In various embodiments, a pitch p, or width between corresponding points on adjacent extensions 118, of polymer substrate 110 may be about 400 nanometers to about 1 micrometer, a height or thickness of extensions 118 ts_{g} may be about 100 nanometers to about 200 nanometers, and a height or thickness of a body 110a of substrate 110 may be about 10 micrometers to about 500 micrometers. Extensions 118 may include straight edges such that the side surfaces and top surface of extensions 118 form an approximately 90° angle, or extensions 118 may include various other shapes such as a rounded top surface, for example (see FIG. 4). When the top surface of extensions 118 are rounded, metal layer 130 may include a vertical layer 126 extending up the sides of the base of extensions 118. In various embodiments, vertical layer 126 may include a thickness t_{fab} of approximately 10 nanometers to about 20 nanometers.

Polarizers 100 that include polymer substrates 110 with upper surfaces 120 that have indentations 116 and extensions 118 are generally referred to as bi-layer structure polarizers, and include metal layer 130 applied to upper surface 120 of polymer substrate 110. In various embodiments, the thin metal wire or grating 130 has a thickness tau of approximately 50 to 100 nanometers. In an exemplary embodiment, metal layer 130 is formed of various metals such as gold, silver, or aluminum, for example. For example, an IR polarizer can function with the same principle of the wire grid polarizer.

In one embodiment, the wire grid polarizer includes a regular array of parallel metallic wires, placed in a plane perpendicular to the incident beam. Electromagnetic waves with electric fields aligned parallel to the wires induce the movement of electrons along the length of the wires. Since the electrons are free to move, the polarizer behaves in a similar manner as the surface of a metal when reflecting light; some energy is lost due to Joule heating in the wires, and the rest of the wave is reflected backwards along the incident beam. Electromagnetic waves with electric fields aligned perpendicular to the wires, the electrons cannot move very far across the width of each wire; therefore, little energy is lost or reflected, and the incident wave is able to travel through the grid. Therefore, the transmitted wave has an electric field purely in the direction perpendicular to the wires, and is thus linearly polarized. For example, the linear polarizer can have a 1) holographic wire grid type and/or 2) ruled wire grid type.

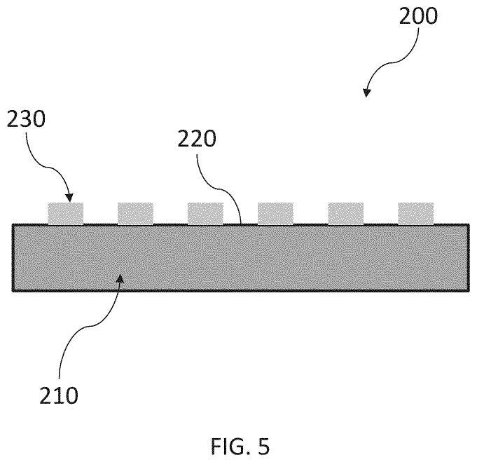

Referring now to FIG. 5, in various embodiments, polymer substrate 210 includes an upper surface 220 that is a smooth continuous surface. Polymer substrates 210 that include a smooth continuous upper surface 220 are generally referred to as single layer grating structures, and typically include an array of thin metal wire or grating 230 closely spaced sitting on its upper surface 220. In various embodiments, the thin metal wire or grating 230 has a thickness tau of approximately 50 to 100 nanometers. In an exemplary embodiment, metal layer 230 is formed of a precious metal such as gold or silver, for example.

Polymer infrared polarizers 100, 200 may be used as lens for various products such as sunglasses, camera lens, or any other kind of optic lens. In various embodiments, polymer infrared polarizers 100, 200 may be a flat, straight lens, while in other various embodiments, polymer infrared polarizers 100, 200 may be a curved lens.

### 2. Methods of Forming Polymer Infrared Polarizers

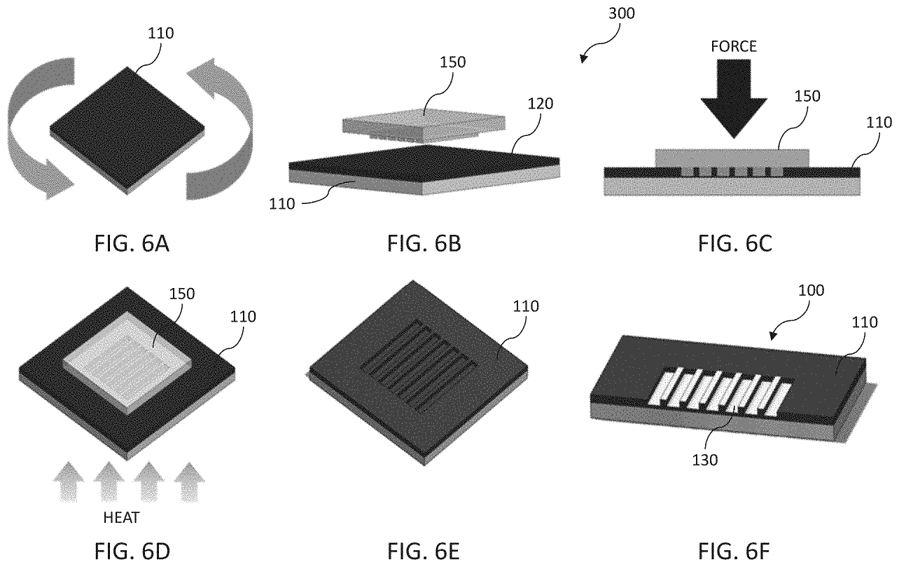

Referring now to FIGS. 6-9, polymer infrared polarizers 100, 200 may be formed via various methods such as stamping, etching, injection molding, 3-D printing (i.e., fuse deposition modeling), and transfer printing, for example.

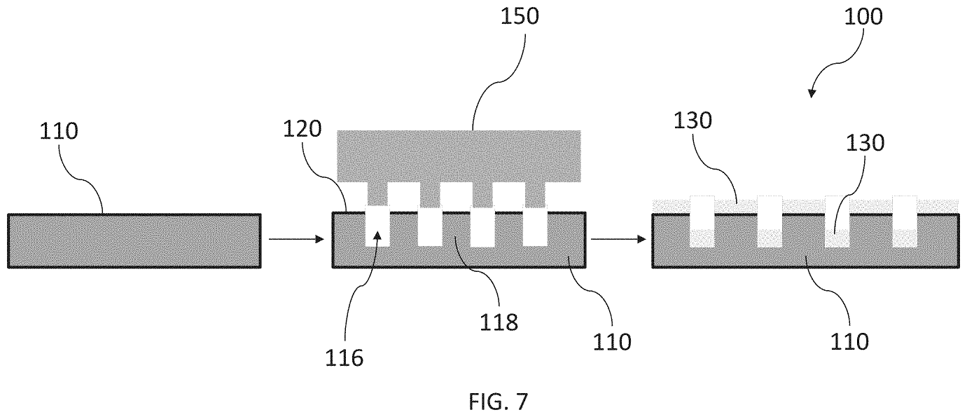

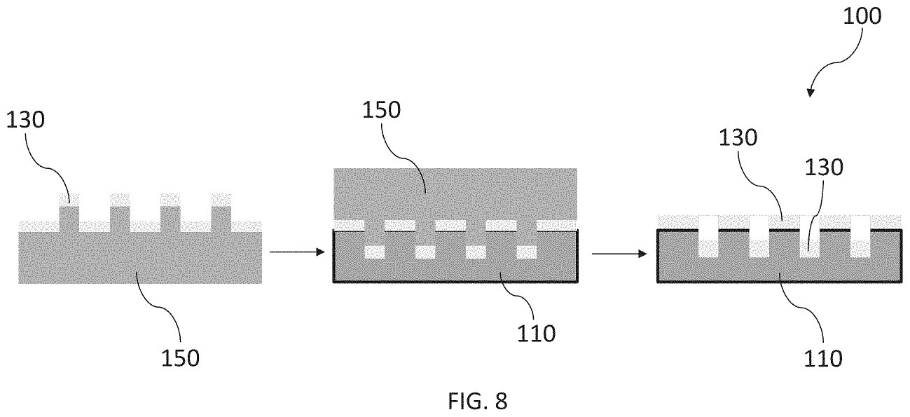

Referring to FIGS. 6 and 7, a stamping method 300 for forming a bi-layer structured polymer infrared polarizer 100 is provided. Stamping method 300 includes providing polymer substrate 110 (FIG. 6A) and a stamp 150 (FIG. 6B). Once provided and prepared, stamp 150 is pressed against upper surface 120 of substrate 110, while heat is applied to substrate 110 (FIGS. 6C and 6D) to produce an indented substrate 110 (FIG. 6E). In various embodiments, the heat applied to substrate 110 may be at a temperature between approximately 160 degrees to 180 degrees. The indented substrate 110 then has a layer of metal 130 applied to upper surface 120. The layer of metal 130 may be applied to upper surface via various methods such as deposition or evaporation, for example. With reference to FIG. 8, another method for applying metal layer 130 to upper surface 120 includes transfer printing. Transfer printing includes a similar process as described above except that metal layer 130 is first applied to stamp 150 before stamp 150 is used to indent substrate 110. When stamp 150 including metal layer 130 is pressed against upper surface 120 of substrate 110 while heat is applied to substrate 110, metal layer 130 transfers from stamp 150 to upper surface 130 of the indented substrate 110.

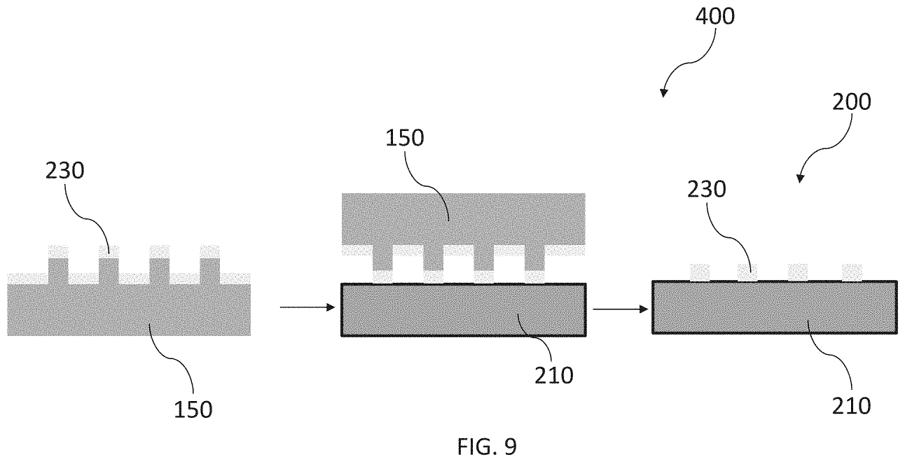

Referring now to FIG. 9, a transfer printing method 400 for forming a single layer with grating structured polymer infrared polarizer 200 is provided. Transfer printing method 400 includes providing polymer substrate 210 and stamp 150, where stamp 150 includes metal layer 230 applied to its surface. As discussed above, metal layer 230 may be applied to stamp 150 via various methods such as deposition or evaporation, for example. Stamp 150 is then pressed against upper surface 220 of substrate 210 without heat being applied to substrate 210. The pressure used to press stamp 150 against substrate 210 causes wires or grates of metal layer 230 to transfer to substrate 210. In various embodiments, the amount of pressure used to press stamp 150 against substrate 210 may be between approximately 10 psi to 30 psi.

In general, the bi-layer structured polarizers of the present disclosure have a better extinction ratio than the single layer with grating structured polarizers of the present disclosure. In addition, polarizers formed via methods of the present disclosure have shorter manufacturing time periods. For example, polarizers of the present disclosure may be formed in approximately one hour as compared to those made with inorganic substrates which take approximately 24 hours to form. Furthermore, the costs of producing polymer substrates of the present disclosure are significantly lower than the costs of producing the inorganic substrates. For instance, the cost of producing a 2 inch disc of polymer substrates of the present disclosure is approximately $1 as compared to the cost of producing a 2 inch disc of some of the inorganic substrates, which can be approximately $3,000. Beyond this, the polymer substrates of the present disclosure are easy to manage/shape and durable, whereas the inorganic substrates are fragile and hard to manage/shape.

In the foregoing specification, specific embodiments of the present disclosure have been described. However, one of ordinary skill in the art will appreciate that various modifications and changes can be made without departing from the scope of the disclosure as set forth in the claims below. Accordingly, the specification and figures are to be regarded in an illustrative rather than a restrictive sense. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued. No claim element herein is to be construed under the provisions of 35 U.S.C. 112(f) unless the element is expressly recited using the phrase “means for.”

1. A polymer infrared polarizer (100, 200) comprising:
a transparent polymer substrate (110, 210) formed of a high sulfur content polymeric material; and
a metal layer (130, 230) fixed to an upper surface (120, 220) of the transparent polymer substrate (110, 210).

2. The polymer infrared polarizer of claim 1, wherein the metal layer (130, 230) is formed of one of gold, silver, and aluminum.

3. The polymer infrared polarizer of claim 1, wherein the upper surface (220) of the transparent polymer substrate (210) is smooth.

4. The polymer infrared polarizer of claim 1, wherein the transparent polymer substrate has indentations (116) within the upper surface.

5. A method for forming a polymer infrared polarizer (100, 200) comprising:
applying a metal layer (130, 230) to an upper surface (120, 220) of a transparent polymer substrate (110, 210), where the transparent polymer substrate is formed of a high sulfur content polymeric material.

6. The method of claim 5, further including altering the upper surface (120, 220) of the transparent polymer substrate (110, 210), wherein the step of altering the upper surface of the transparent polymer substrate includes one of stamping, injection molding, 3-D printing, and an etching of the substrate.

7. The method of claim 5, wherein the step of altering the upper surface (120, 220) of the transparent polymer substrate (110, 210) occurs one of prior to and simultaneously with the step of applying the metal layer to the upper surface of the transparent polymer substrate.

8. The method of claim 5, wherein the step of applying the metal layer (130, 230) to the upper surface (120, 220) of the transparent polymer substrate (110, 210) includes one of deposition, evaporation, and transfer printing of the metal layer onto the upper surface.

9. The method of claim 5, wherein the upper surface (220) is smooth and continuous.

10. The method of claim 5, wherein the upper surface (120) includes indentations (116).

11. A polymer infrared polarizer (100, 200) comprising:
a transparent polymer substrate (110, 210) having an upper surface (120, 220); and
a metal layer (130, 230) disposed on the upper surface (120, 220) of the transparent polymer substrate (110, 210),
wherein the transparent polymer substrate (110, 210) includes a polymeric composition having a copolymer of sulfur.

12. The polymer infrared polarizer of claim 11, wherein the upper surface of the transparent polymer substrate includes a plurality of spaced apart indentations (116) creating a plurality of upward extensions (118).

13. The polymer infrared polarizer of claim 12, wherein the upper surface of the transparent polymer substrate includes a top upper surface (122) including tops of each extension of the plurality of extensions (118), and a bottom upper surface (123) including surfaces between each extension of the plurality of extensions (118).

14. The polymer infrared polarizer of claim 12, wherein a pitch between corresponding points on adjacent extensions (118) of the transparent polymer substrate is approximately 400 nanometers to approximately 1 micrometer.

15. The polymer infrared polarizer of claim 12, wherein a height of each extension of the plurality of extensions (118) is approximately 100 nanometers to approximately 200 nanometers.

16. The polymer infrared polarizer of claim 12, wherein a height of a body (110a) of the transparent polymer substrate (110, 210) is approximately 10 micrometers to approximately 500 micrometers.

17. The polymer infrared polarizer of claim 12, wherein each extension of the plurality of extensions (118) includes straight edges such that side surfaces and a top surface of each extension of the plurality of extensions form an approximately 90-degree angle.

18. The polymer infrared polarizer of claim 12, wherein each extension of the plurality of extensions (118) includes a rounded top surface.

19. The polymer infrared polarizer of claim 12, wherein the metal layer (130) includes a vertical layer (126) extending up sides of a base of each extension of the plurality of extensions (118).

20. The polymer infrared polarizer of claim 11, wherein the upper surface (120, 220) of the transparent polymer substrate (110, 210) includes at least one of: a bi-layer structure or a single-layer structure.
